(19) United States
(12) Patent Application Publication
(10) Pub. No.: US 2025/0184817 A1
(43) Pub. Date: Jun. 5, 2025

(54) COMMUNICATION DEVICE AND COMMUNICATION SYSTEM

(71) Applicant: Fujitsu Limited, Kawasaki-shi Kanagawa (JP)

(72) Inventors: Yuzo ITO, Yokohama (JP); Koji OGAWA, Yokohama (JP); Yasunori OTSUKA, Edogawa (JP); TERUYOSHI WATANABE, Kawasaki (JP)

(73) Assignee: Fujitsu Limited, Kawasaki-shi Kanagawa (JP)

(21) Appl. No.: 19/051,332

(22) Filed: Feb. 12, 2025

Related U.S. Application Data
(63) Continuation of application No. PCT/JP2022/036437, filed on Sep. 29, 2022.

(51) Int. Cl. H04W 28/06; H04L 67/303; H04W 28/18

(52) U.S. Cl. CPC H04W 28/06; H04L 67/303; H04W 28/18

(57) ABSTRACT

A communication device that accommodates a radio terminal in a radio access network, the communication device includes an interface circuit configured to communicate with a second communication device, a storage configured to store control information that includes a first profile that represents a function provided by the communication device and a communication parameter that corresponds to the first profile, and processor circuitry configured to edit the control information, wherein the interface circuit transmits the first profile to the second communication device, and receives a second profile, the processor circuitry edits the control information based on the second profile, the interface circuit transmits the edited control information to the second communication device, and when the second communication device determines that a communication parameter related to the function provided by the second communication device is supported by the communication device, the communication device starts a communication service.

### CROSS-REFERENCE TO RELATED APPLICATION

This application is a continuation application of International Application PCT/JP2022/036437 filed on Sep. 29, 2022 and designated the U.S., the entire contents of which are incorporated herein by reference.

### FIELD

The embodiment discussed herein is related to a communication device and a communication system for radio communication.

### BACKGROUND

A radio access network (RAN) of a fifth generation (5G) network includes a distributed unit (DU) and a radio unit (RU) in many cases. The DU provides radio link control (RLC), media access control (MAC), a physical layer (PHY)-High function, and the like. For example, the DU processes a signal in an upper layer. The RU provides a PHY-Low function, radio frequency (RF) processing, and the like. For example, the RU may accommodate a radio terminal.

Since before, an interface between the DU and the RU has been designed for each vendor of a communication device. However, in recent years, opening of the interface of the radio access network has been promoted. For example, specifications of the interface of the radio access network and the communication device are defined by open radio access network (Open RAN (O-RAN)) alliance. In this case, when each vendor provides a communication device conforming to an O-RAN, the communication devices of the different vendors may be mutually coupled.

Note that a fronthaul interface of the O-RAN is described in, for example, International Publication Pamphlet No. WO 2021/117245.

International Publication Pamphlet No. WO 2021/117245 is disclosed as related art.

### SUMMARY

According to an aspect of the embodiments, a communication device that accommodates a radio terminal in a radio access network, the communication device includes an interface circuit configured to communicate with a second communication device that processes a signal of the communication device in the radio access network, a storage configured to store a first profile that represents information related to a function provided by the communication device and control information that includes a communication parameter that corresponds to the first profile, and a processor configured to edit the control information, wherein the interface circuit transmits the first profile to the second communication device, and receives a second profile that represents information related to a function provided by the second communication device from the second communication device, the processor edits the control information based on the second profile, the interface circuit transmits the edited control information to the second communication device, and in the second communication device, when it is determined that a communication parameter related to the function provided by the second communication device is supported by the communication device based on the edited control information, the communication device starts a communication service based on the edited control information.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRA WINGS

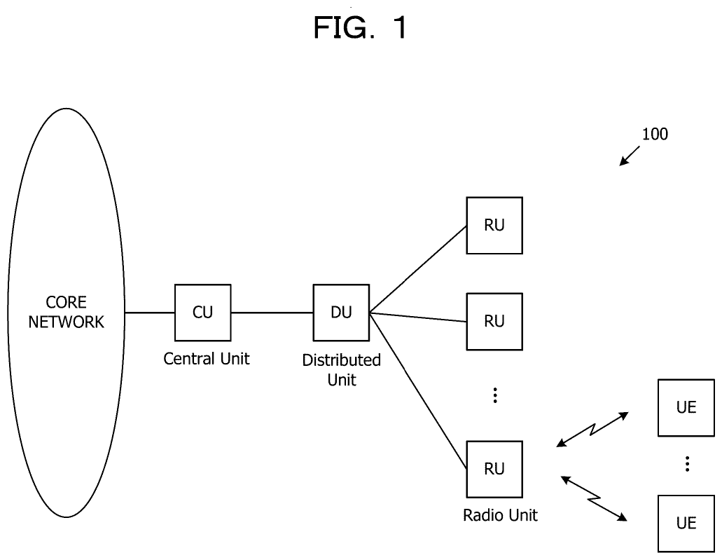

FIG. 1 is a diagram illustrating an example of a communication system according to an embodiment;

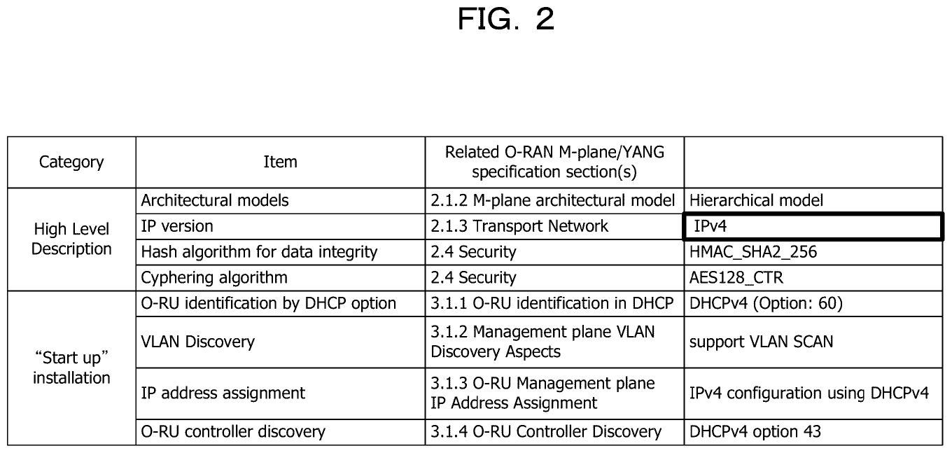

FIG. 2 is a diagram illustrating an example of a profile defining a management (M) plane interface between a distributed unit (DU) and a radio unit (RU);

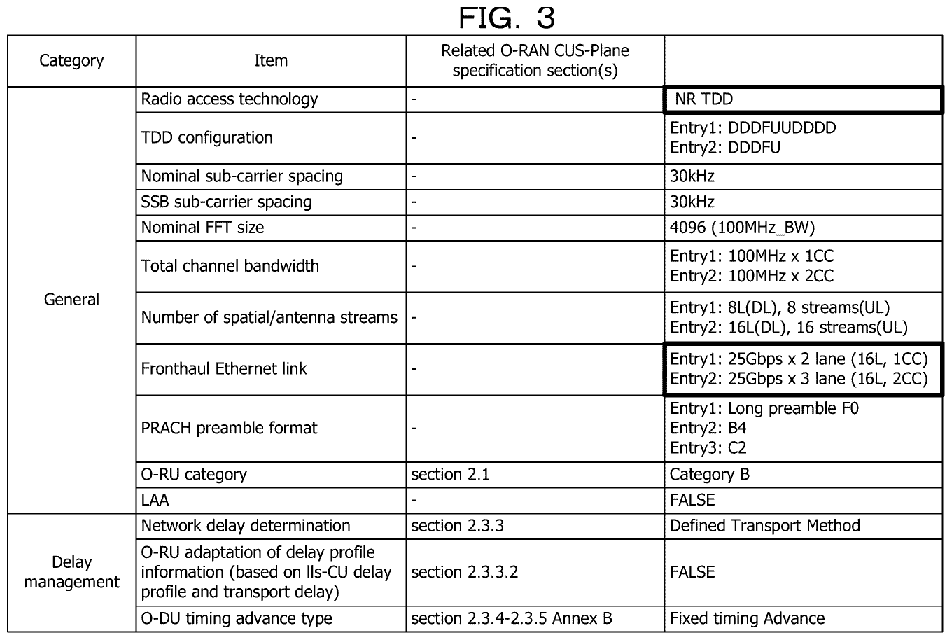

FIG. 3 is a diagram illustrating another example of a profile defining a control (C)/user (U)/synchronization(S) plane interface between the DU and the RU;

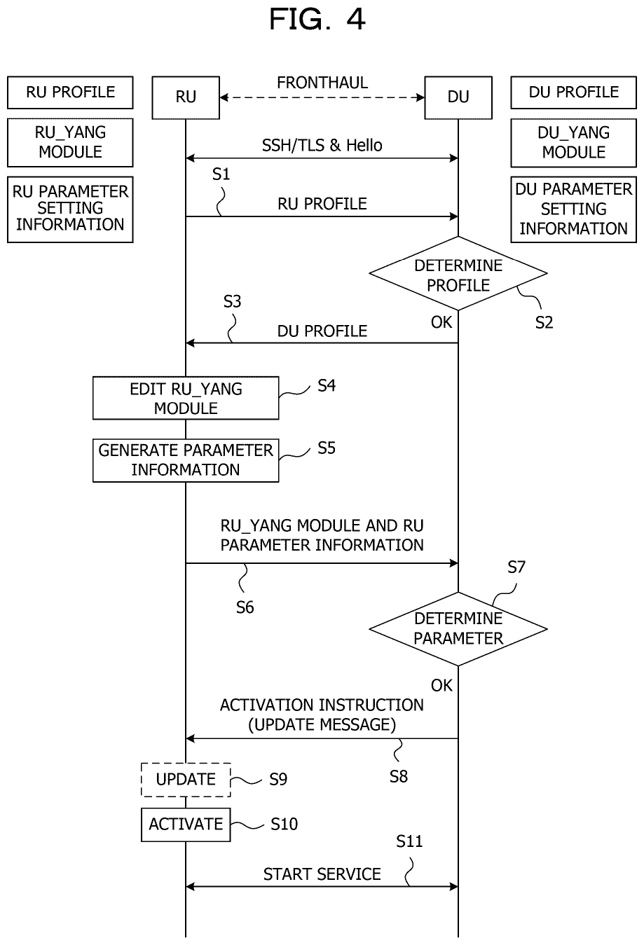

FIG. 4 is a diagram illustrating an example of a sequence for determining whether or not of mutual coupling between the DU and the RU is possible;

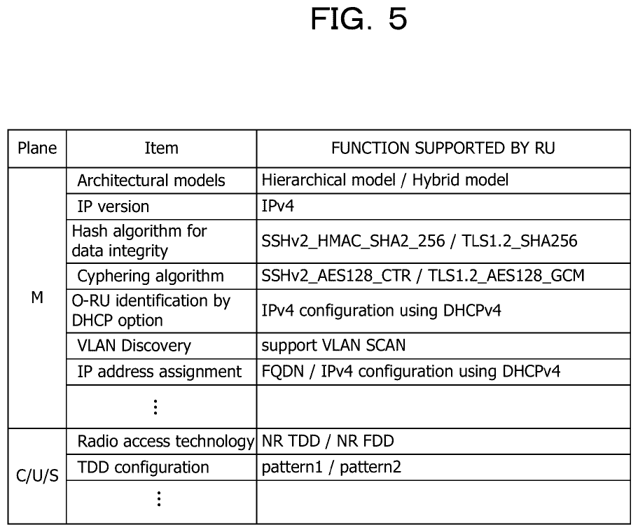

FIG. 5 is a diagram illustrating an example of RU profile information set in the RU;

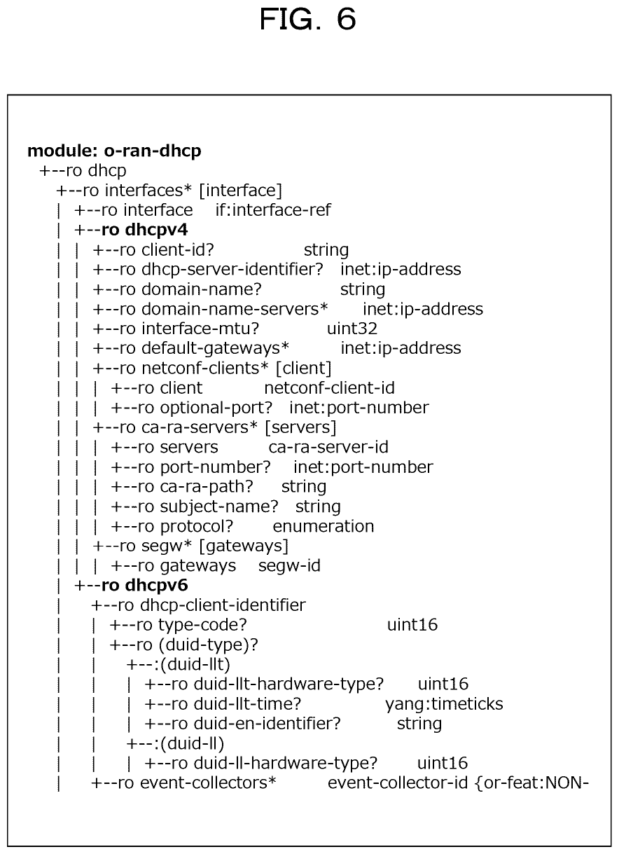

FIG. 6 is a diagram (part 1) illustrating an example of a yet another next generation (YANG) module set in the RU;

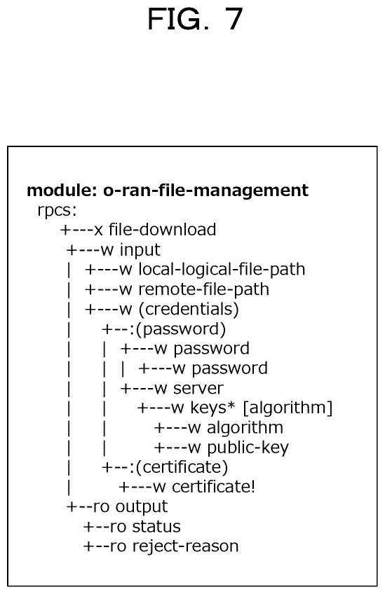

FIG. 7 is a diagram (part 2) illustrating an example of the YANG module set in the RU;

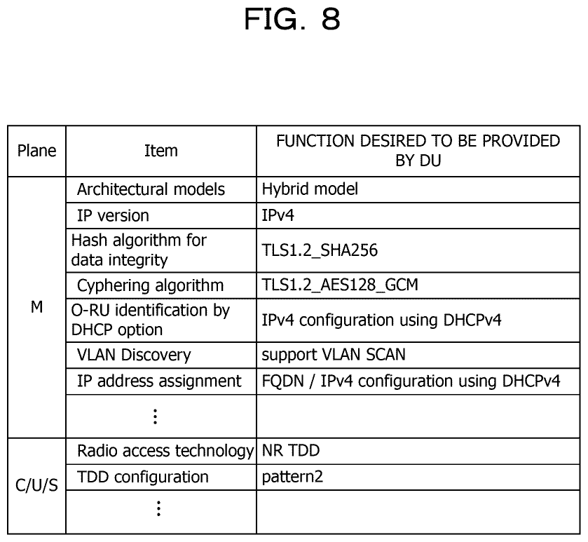

FIG. 8 is a diagram illustrating an example of DU profile information set in the DU;

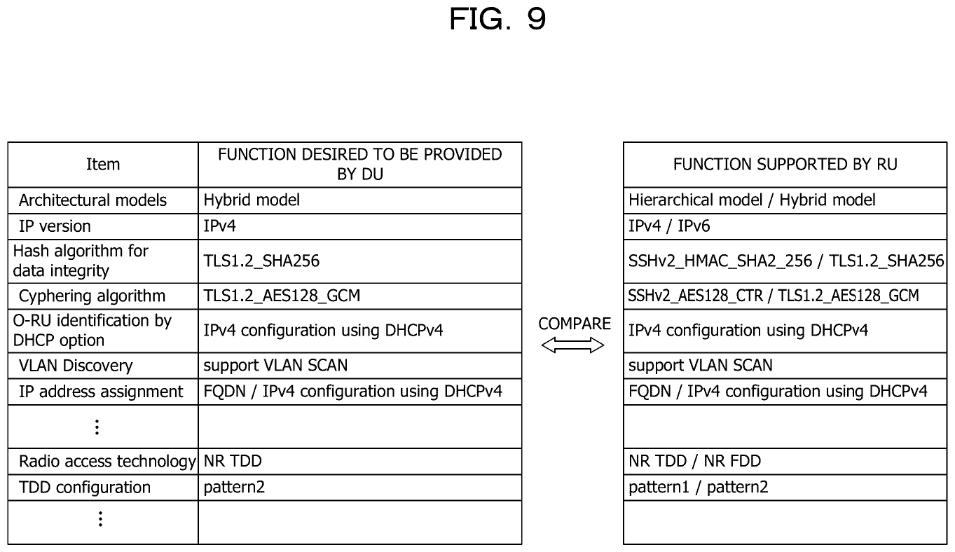

FIG. 9 is a diagram illustrating an example of comparison of the profile information;

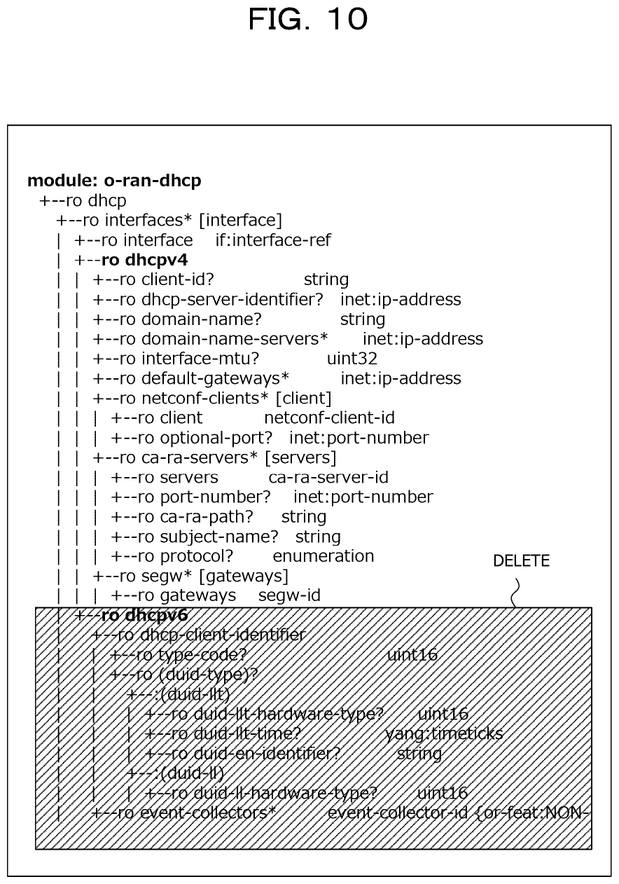

FIG. 10 is a diagram illustrating an example of editing of the YANG module;

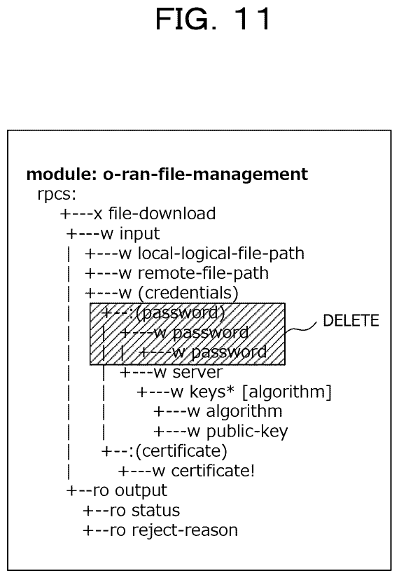

FIG. 11 is a diagram illustrating another example of the editing of the YANG module;

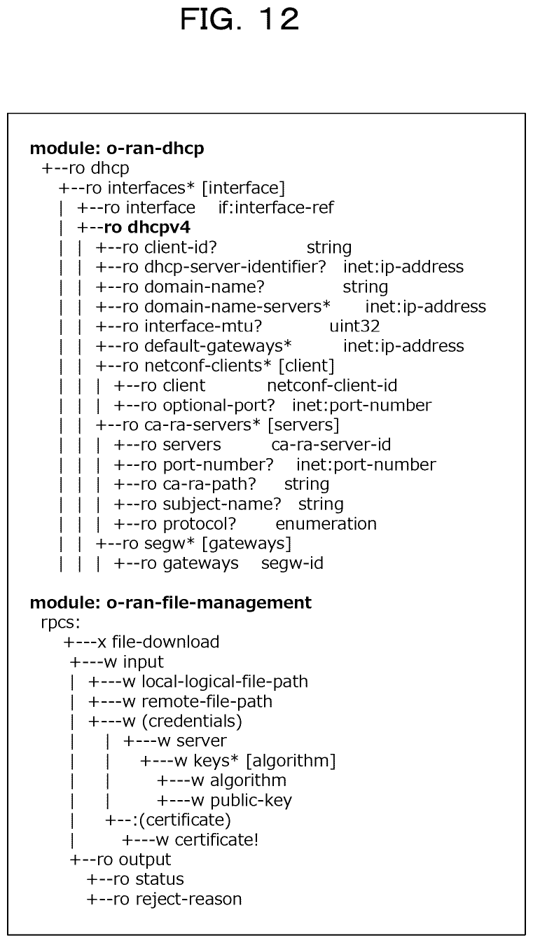

FIG. 12 is a diagram illustrating an example of an RU_YANG module edited with procedures illustrated in FIGS. 10 and 11;

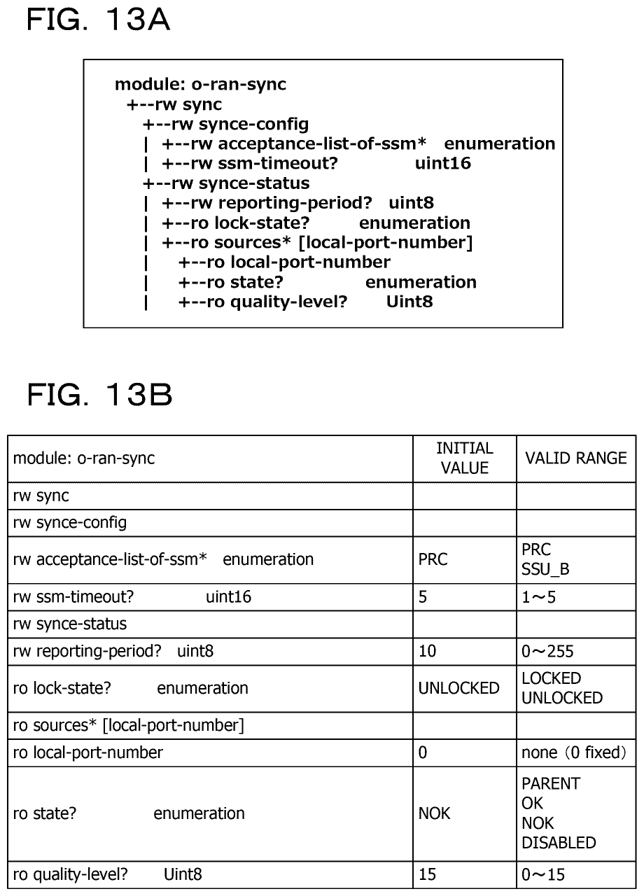

FIGS. 13A and 13B are diagrams illustrating examples of an initial value and a range of each parameter in the YANG module set in the RU;

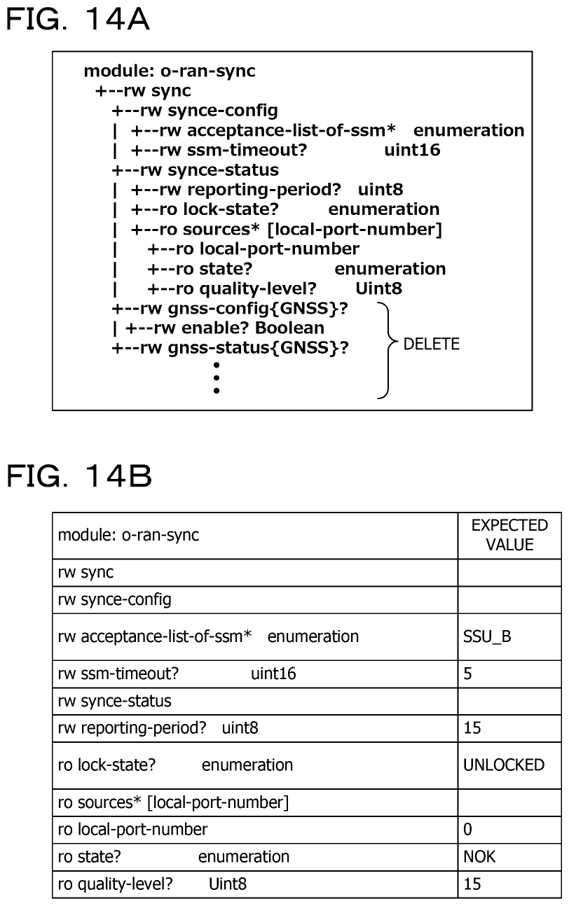

FIGS. 14A and 14B are diagrams illustrating examples of an expected value of each parameter in the YANG module set in the DU;

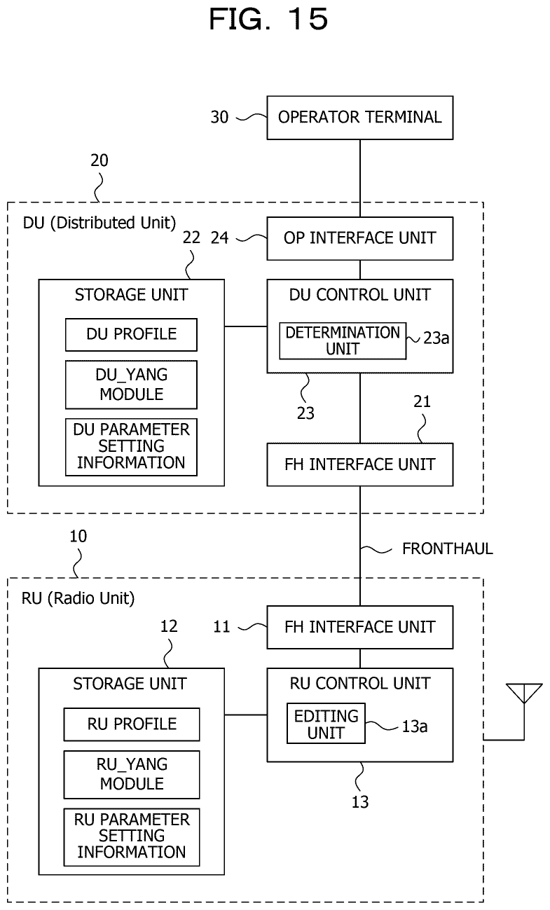

FIG. 15 is a block diagram representing functions of the communication device RU and the communication device DU;

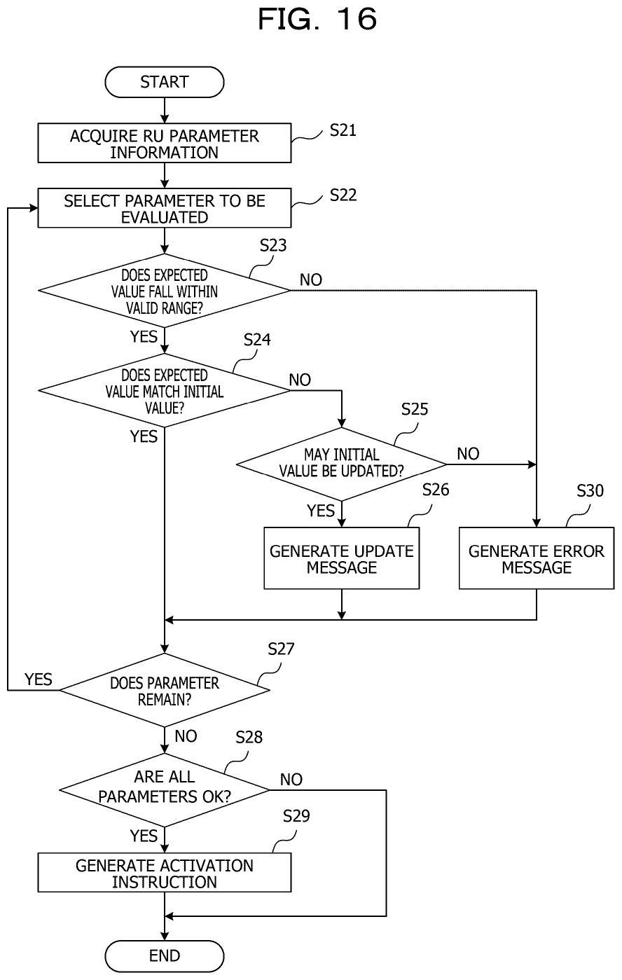

FIG. 16 is a flowchart illustrating an example of processing of a determination unit; and

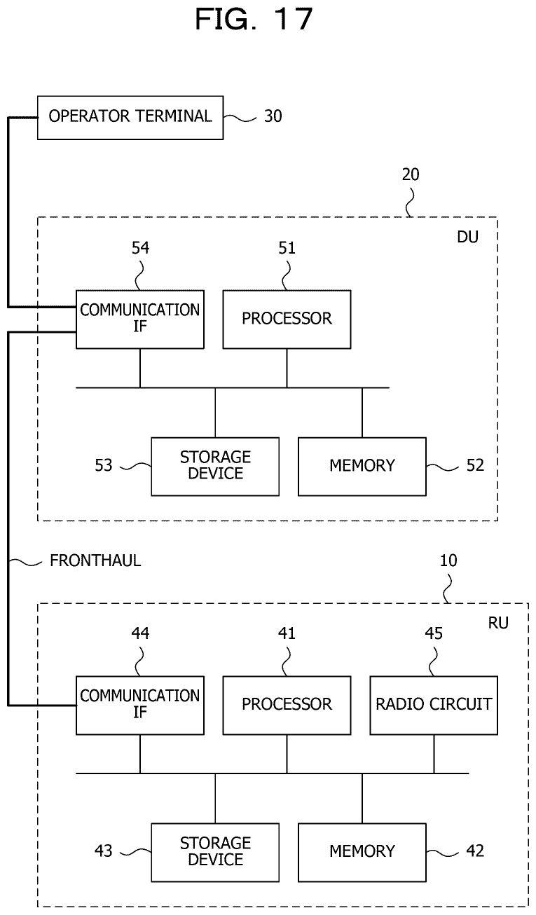

FIG. 17 is a diagram illustrating an example of hardware configurations of the communication devices.

### DESCRIPTION OF EMBODIMENTS

Note that the O-RAN does not define all specifications for coupling the DU and the RU. Therefore, even in a case where each vendor provides the communication device conforming to the O-RAN, the communication devices may not be mutually coupled due to functions of the communication devices, profiles used by the communication devices, a difference in version of the O-RAN to which the communication devices conform, or the like.

An object according to one aspect of an embodiment is to provide a method for determining whether or not coupling between communication devices constituting a radio access network is possible.

FIG. 1 illustrates an example of a communication system according to an embodiment. In this embodiment, a communication system 100 includes a central unit (CU), a distributed unit (DU), a radio unit (RU), and a radio terminal. The DU and the RU constitute a radio access network, as described above. For example, the RU may provide a physical layer (PHY)-Low function, radio frequency (RF) processing, and the like, and accommodate the radio terminal. Therefore, the RU is an example of a radio device that accommodates the radio terminal in the radio access network. The DU provides radio link control, media access control, a PHY-High function, and the like, and processes a signal of the RU in an upper layer. Note that a plurality of the RUs may be coupled to the DU. For example, the DU may process signals of the plurality of RUs. The CU is provided between a core network and the DU, and processes a signal of the DU in a further upper layer. The radio terminal is not particularly limited, but is, for example, user equipment (UE).

The DU and the RU are mutually coupled by a known interface. In this embodiment, the interface between the DU and the RU is a fronthaul interface defined by open radio access network (O-RAN) alliance.

The radio access network is set using, for example, a network configuration (NETCONF) protocol. The NETCONF is one of standard transport protocols for communicating with network devices. For example, the NETCONF provides a function of editing setting data, a mechanism of acquiring operation data from the network device, and the like.

In the NETCONF, a yet another next generation (YANG) modeling language is used. For example, in the NETCONF, the network device is set based on data described in the YANG. The YANG is one of modeling languages developed for the purpose of describing structures such as setting items, states, and procedure calls of the network device in a form easily interpreted by a person. Note that data obtained by abstracting a setting value and the structure of the network device by using the YANG may be referred to as a “YANG data model” or a “YANG module”.

Furthermore, the O-RAN working group (WG) 4 creates an interoperability test specification (IOT SPEC) that is a specification that defines functions to be used at the time of mutual coupling. In this specification, functions to be used are listed for each item. Note that listed content may be referred to as an “IOT profile” or simply a “profile”.

FIGS. 2 and 3 illustrate examples of profiles defining the interface between the DU and the RU. In the profile illustrated in FIG. 2, for example, it is defined that an Internet protocol version 4 (IPv4) is used in a management (M) plane. In this case, each of the DU and the RU needs to support a function of performing communication in the IPV4. In the profile illustrated in FIG. 3, for example, each of the DU and the RU needs to support a function of performing communication in a new radio time division duplex (NR TDD) scheme in a control (C)/user (U)/synchronization(S) plane. Furthermore, a plurality of functions (or operation conditions) may be set for each item. For example, in the example illustrated in FIG. 3, two functions as a fronthaul Ethernet link (Ethernet is a registered trademark) are set. In this case, each of the DU and the RU needs to support at least one of the two functions.

FIG. 4 illustrates an example of a sequence for determining whether or not of mutual coupling between the DU and the RU is possible. This sequence is started when, for example, the RU is activated. Note that, in the following description, the RU and the DU may be referred to as a communication device RU and a communication device DU, respectively.

In a memory of the communication device RU, RU profile information, an RU_YANG module, and RU parameter setting information are stored. Note that, for example, the RU profile information, the RU_YANG module, and the RU parameter setting information are created by a vendor of the communication device RU, and are written in the memory of the communication device RU.

The RU profile information defines functions that may be used by the communication device RU in mutual coupling between the communication device RU and the communication device DU, and is created according to specifications of the O-RAN. An example of the RU profile information is illustrated in FIG. 5. According to the RU profile information illustrated in FIG. 5, the communication device RU supports, for example, a hierarchical model and a hybrid model as architecture models. Furthermore, the communication device RU supports the IPv4.

The RU_YANG module is created based on the RU profile information, and represents setting and a structure of the communication device RU by using the YANG. An example of the RU_YANG module is illustrated in FIGS. 6 and 7. In FIG. 6, information related to a dynamic host configuration protocol (DHCP) is described. In FIG. 7, information related to file management is described.

The RU parameter setting information represents initial values and a valid range of parameters used in the RU_YANG module in the communication device RU, and the like. Note that the RU parameter setting information may be a part of the RU_YANG module.

Similarly, in a memory of the communication device DU, DU profile information, a DU_YANG module, and DU parameter setting information are stored. Note that, for example, the DU profile information, the DU_YANG module, and the DU parameter setting information are created by a vendor of the communication device DU or an administrator of the radio access network including the communication device DU, and are written in the memory of the communication device DU.

The DU profile information defines functions that are desired to be provided by the communication device DU in mutual coupling between the communication device RU and the communication device DU, and is created according to the specifications of the O-RAN. Here, the functions that are desired to be provided by the communication device DU include services that are desired to be started by the communication device DU. An example of the DU profile information is illustrated in FIG. 8. According to the DU profile information illustrated in FIG. 8, the communication device DU uses, for example, a hybrid model as architecture models. Furthermore, the communication device DU uses the IPV4.

The DU_YANG module is created based on the DU profile information, and represents setting and a structure of the communication device DU by using the YANG. The DU parameter setting information represents expected values of parameters used in the DU_YANG module in the communication device DU, and the like. The expected value represents the function that is desired to be provided by the communication device DU or the service that is desired to be started by the communication device DU. Note that the DU parameter setting information may be a part of the DU_YANG module.

The description returns to FIG. 4. In the sequence illustrated in FIG. 4, when the communication device RU is activated, a link is established between the communication device RU and the communication device DU. The link is established in a secure sockets layer (SSL) or transport layer security (TLS) in this embodiment. The SSL/TLS is a protocol for performing authentication and encrypted communication. Therefore, when the communication device RU is activated, for example, the communication device RU operates as a client. In this case, the communication device RU transmits a client Hello message to the communication device DU, thereby starting an SSL/TLS procedure.

When the link is established between the communication device RU and the communication device DU, in S1, the communication device RU reads the RU profile information from the memory of the communication device RU. Then, the communication device RU transmits the RU profile information to the communication device DU. For example, the communication device DU acquires the RU profile information representing information related to the functions provided by the communication device RU from the communication device RU. Note that an example of the RU profile information is as illustrated in FIG. 5.

In S2, the communication device DU reads the DU profile information from the memory of the communication device DU. An example of the DU profile information is as illustrated in FIG. 8. Then, as illustrated in FIG. 9, the communication device DU compares the DU profile information with the RU profile information acquired from the communication device RU. For example, the communication device DU determines, based on the DU profile information and the RU profile information, whether or not the functions (including the services) that are desired to be provided by the communication device DU are supported by the communication device RU.

For example, according to the DU profile information, the communication device DU uses the hybrid model as the architecture models. On the other hand, according to the RU profile information, the communication device RU supports the hierarchical model and the hybrid model as the architecture models. For example, the architecture models that are desired to be provided by the communication device DU are supported by the communication device RU. Furthermore, the communication device DU communicates data of the management plane in the IPV4. On the other hand, the communication device RU supports the IPV4 and an Internet protocol version 6 (IPv6). For example, a communication protocol (IPv4) that is desired to be used by the communication device DU is supported by the communication device RU.

Similarly, the communication device DU determines, for each item of the DU profile information, whether or not the function that is desired to be provided by the communication device DU is supported by the communication device RU. Then, when the function that is desired to be provided by the communication device DU is not supported by the communication device RU in one or more items in the DU profile information, the communication device DU transmits an error message to an operator terminal. In this case, the error message includes, for example, information identifying the function not supported by the communication device RU. Note that the operator terminal is a computer operated by the administrator of the radio access network.

When the functions that are desired to be provided by the communication device DU are supported by the communication device RU in all the items of the DU profile information, the communication device DU transmits the DU profile information to the communication device RU in S3. An example of the DU profile information is as illustrated in FIG. 8.

In S4, the communication device RU edits the RU_YANG module based on the DU profile information received from the communication device DU. At this time, the communication device RU deletes description related to a function not needed by the communication device DU in the RU_YANG module.

For example, it is assumed that the RU_YANG module illustrated in FIG. 6 is set in the communication device RU. Here, it is assumed that the communication device RU supports the IPv4 and the IPV6. For example, description related to the IPV4 (ro dhcpv4) and description related to the IPv6 (ro dhcpv6) are described in the RU_YANG module. Then, the communication device RU receives the DU profile information illustrated in FIG. 8 from the communication device DU. Here, according to the DU profile information, the communication device DU performs communication in the IPV4. In this case, in the RU_YANG module, the description related to the IPV6 (ro dhcpv6) is unnecessary. Therefore, the communication device RU deletes the description related to the IPV6 (ro dhcpv6) from the RU_YANG module as illustrated in FIG. 10, based on the DU profile information.

Furthermore, it is assumed that the RU_YANG module illustrated in FIG. 7 is set in the communication device RU. Here, it is assumed that the communication device RU supports authentication using a password. For example, information related to password authentication is described in the RU_YANG module. Then, the communication device RU receives the DU profile information illustrated in FIG. 8 from the communication device DU. Here, according to the DU profile information, the communication device DU uses the TLS. Note that, in the TLS, mutual authentication is performed without using a password. In this case, in the RU_YANG module, the description related to the password is unnecessary. Therefore, the communication device RU deletes the description related to the password from the RU_YANG module as illustrated in FIG. 11, based on the DU profile information.

FIG. 12 illustrates an example of the RU_YANG module edited with procedures illustrated in FIGS. 10 and 11. In this manner, the communication device RU deletes the description that does not correspond to the functions provided by the communication device DU in the RU_YANG module.

In S5, the communication device RU determines an initial value and a valid range that correspond to each parameter in the edited RU_YANG module. Here, the initial value and the valid range of each parameter related to an operation of the communication device RU are stored in advance in the memory of the communication device RU as the RU parameter setting information illustrated in FIG. 4. Furthermore, it is assumed that the RU_YANG module illustrated in FIG. 13A is obtained in the communication device RU by editing based on the DU profile information. In this case, the communication device RU may determine the initial value and the valid range for each parameter in the RU_YANG module as illustrated in FIG. 13B by referring to the RU parameter setting information prepared in advance. Note that, in the following description, information representing the initial value and the valid range of each parameter of the communication device RU may be referred to as “RU parameter information”. Furthermore, the RU_YANG module to which the RU parameter information is assigned may be referred to as “parameter mapping data”.

In this embodiment, for example, “PRC” and “PRC, SSU_B” are set as the initial value and the valid range of “rw acceptance-list-of-ssm”, respectively. This state represents that the communication device RU supports the PRC and the SSU_B, and a default operation state is the PRC. Furthermore, “5” and “1 to 5” are set as the initial value and the valid range of “rw ssw-timeout?”, respectively. This state represents that the valid range of an SSW timeout in the communication device RU is “1 to 5” and the default operation state is “1”.

In S6, the communication device RU transmits the parameter mapping data to the communication device DU. For example, the communication device DU acquires the parameter mapping data from the communication device RU. The parameter mapping data corresponds to the edited RU_YANG module and the RU parameter information representing the initial value and the valid range of each parameter used by the communication device RU.

In S7, the communication device DU checks consistency between communication parameters set in the communication device RU and communication parameters used by the communication device DU. The communication parameters set in the communication device RU are represented by the parameter mapping data transmitted from the communication device RU to the communication device DU. Furthermore, the communication parameters used by the communication device DU are obtained by referring to the DU parameter setting information illustrated in FIG. 4 based on the DU_YANG module. At this time, the DU_YANG module includes description related to the functions/services that are desired to be started by the communication device DU. For example, it is assumed that description not related to the functions/services that are desired to be started by the communication device DU is deleted from the DU_YANG module. Furthermore, the DU parameter setting information represents the expected values of the communication parameters representing the functions/services that are desired to be started by the communication device DU, is created by the vendor of the communication device DU or the administrator of the radio access network including the communication device DU, and is written in the memory.

For example, the DU_YANG module illustrated in FIG. 14A is set in the communication device DU. Note that the communication device DU does not use a global navigation satellite system (GNSS). Therefore, description related to the GNSS is deleted in the DU_YANG module. Then, the communication device DU specifies the expected value corresponding to each parameter in the DU_YANG module as illustrated in FIG. 14B by referring to the DU parameter setting information. The expected value of the parameter represents specific content of the function/service that is desired to be started by the communication device DU.

Subsequently, the communication device DU determines whether or not the expected value of each parameter in the DU_YANG module is supported by the communication device RU. Here, it is assumed that the expected values illustrated in FIG. 14B are set in the communication device DU. Furthermore, it is assumed that the communication device DU receives the RU parameter information illustrated in FIG. 13B from the communication device RU.

For example, determination for “acceptance-list-of-ssm” is as follows. Note that it is assumed that a value of this parameter may be rewritten in the communication device RU according to an instruction from the communication device DU. In the examples illustrated in FIGS. 13A to 14B, the parameter to which “rw” is assigned may be rewritten in the communication device RU, and the parameter to which “ro” is assigned may not be rewritten in the communication device RU.

First, it is determined whether or not the expected value of the communication device DU falls within the valid range of the communication device RU. In this example, the expected value of the communication device DU is “SSU_B”, and the valid range in the communication device RU is “PRC, SSU_B”. Therefore, the expected value of the communication device DU falls within the valid range of the communication device RU. In this case, the expected value of the communication device DU is compared with the initial value of the communication device RU. In this example, the initial value in the communication device RU is “PRC”. For example, the initial value of the communication device RU is different from the expected value of the communication device DU. In this case, whether or not the parameter to be determined may be rewritten in the communication device RU is checked. In this embodiment, “rw” is assigned to this parameter, and the parameter may be rewritten in the communication device RU. Therefore, the communication device DU generates an update message instructing to rewrite the value of this parameter from “PRC” to “SSU_B”. Note that, when the expected value of the communication device DU does not fall within the valid range of the communication device RU, an error message is generated. Furthermore, when the initial value of the communication device RU matches the expected value of the communication device DU, an OK message is generated and the next parameter is selected.

Determination for “lock-state” is as follows. Note that it is assumed that a value of this parameter may not be rewritten in the communication device RU according to an instruction from the communication device DU.

It is determined whether or not the expected value of the communication device DU falls within the valid range of the communication device RU. In this example, the expected value of the communication device DU is “UNLOCKED”, and the valid range in the communication device RU is “LOCKED, UNLOCKED”. Therefore, the expected value of the communication device DU falls within the valid range of the communication device RU. In this case, the expected value of the communication device DU is compared with the initial value of the communication device RU. In this example, the initial value in the communication device RU is “UNLOCKED”. For example, the initial value of the communication device RU matches the expected value of the communication device DU. In this case, an OK message is generated.

The value of this parameter may not be rewritten in the communication device RU according to an instruction from the communication device DU. Therefore, when the initial value of the communication device RU is different from the expected value of the communication device DU, the communication device DU and the communication device RU may not be able to communicate with each other. For example, in a case where the initial value of the communication device RU is “LOCKED”, even when the expected value of the communication device DU falls within the valid range in the communication device RU, the values of the parameters may not be matched between the communication device DU and the communication device RU. Therefore, in this case, an error message is generated.

As described above, the communication device DU determines whether or not each parameter in the DU_YANG module is supported in the communication device RU. Then, when all the parameters are supported in the communication device RU, the communication device DU transmits an activation instruction to the communication device RU in S8. Furthermore, when an update message is generated for one or a plurality of parameters, the communication device DU transmits the activation instruction and the update message to the communication device RU. Note that, when an error message is generated for one or a plurality of parameters, the communication device DU transmits the error message to the operator terminal without transmitting the activation instruction to the communication device RU.

When receiving the activation instruction and the update message, the communication device RU updates, in S9, the value of the corresponding parameter in the RU_YANG module. For example, in the embodiment illustrated in FIGS. 13A to 14B, the communication device RU receives an update message instructing to update the value of “acceptance-list-of-ssm” from “PRC” to “SSU_B”. In this case, the communication device RU updates the value of “acceptance-list-of-ssm” from “PRC” to “SSU_B”.

In S10, the communication device RU activates a circuit in the communication device DU according to the received activation instruction. Thereafter, in S11, the communication device DU and the communication device RU start a communication service.

In this manner, in the radio access network according to the embodiment, when the communication device RU is activated, it is determined whether the communication parameters related to the functions/services that are desired to be provided by the communication device DU are supported by the communication device RU. Then, when the communication parameter related to the function/service that is desired to be provided by the communication device DU is not supported by the communication device RU, an error message representing the communication parameter not supported by the communication device RU is generated. Therefore, when there is a problem in mutual coupling between the communication device DU and the communication device RU, the administrator of the radio access network may easily recognize the problem before starting a service. As a result, effort for constructing the radio access network is reduced.

FIG. 15 is a block diagram representing functions of the communication device RU and the communication device DU. The communication device RU and the communication device DU are mutually coupled via fronthaul.

A communication device RU 10 includes a fronthaul (FH) interface unit 11, a storage unit 12, and an RU control unit 13. The FH interface unit 11 communicates with a communication device DU 20 via the fronthaul. Furthermore, the communication device RU 10 includes a radio antenna and may accommodate the radio terminal.

In the storage unit 12, the RU profile information, the RU_YANG module, and the RU parameter setting information are stored. As illustrated in FIG. 5, the RU profile information represents the functions/services supported by the communication device RU 10 in mutual coupling between the communication device RU 10 and the communication device DU 20. The RU_YANG module is created based on the RU profile information, and represents, as illustrated in FIGS. 6 and 7, the setting and the structure of the communication device RU 10. Note that the RU_YANG module is an example of control information including the communication parameters corresponding to the RU profile information. The RU parameter setting information represents the initial value and the valid range of the parameters used in the RU_YANG module in the communication device RU 10, and the like.

The RU control unit 13 controls an operation of the communication device RU 10. Furthermore, the RU control unit 13 includes an editing unit 13a. The editing unit 13a edits the RU_YANG module based on the DU profile information received from the communication device DU 20. For example, the editing unit 13a deletes description not related to a function provided by the communication device DU 20 from the RU_YANG module based on the DU profile information. In the example illustrated in FIG. 10, the description related to the IPV6 is deleted from the RU_YANG module by the editing unit 13a. Furthermore, the editing unit 13a refers to the RU parameter setting information, and generates the RU parameter information representing the initial value and the valid range of each communication parameter included in the edited RU_YANG module. Note that the edited RU_YANG module and the RU parameter information are transmitted to the communication device DU 20 by the FH interface unit 11.

The communication device DU 20 includes an FH interface unit 21, a storage unit 22, a DU control unit 23, and an operator (OP) interface unit 24. The FH interface unit 21 communicates with the communication device RU 10 via the fronthaul. The OP interface unit 24 communicates with an operator terminal 30.

In the storage unit 22, the DU profile information, the DU_YANG module, and the DU parameter setting information are stored. As illustrated in FIG. 8, the DU profile information represents the functions/services that are desired to be provided by the communication device DU 20 in mutual coupling between the communication device RU 10 and the communication device DU 20. The DU_YANG module is created based on the DU profile information, and represents the setting and the structure of the communication device DU 20. Note that the DU_YANG module is an example of the control information including the communication parameters corresponding to the DU profile information. The DU parameter setting information represents the expected values of the parameters used in the DU_YANG module in the communication device DU 20, and the like.

The DU control unit 23 controls an operation of the communication device DU 20. Furthermore, the DU control unit 23 includes a determination unit 23a. The determination unit 23a determines whether or not the functions/services provided by the communication device DU 20 are supported by the communication device RU 10. For example, when the FH interface unit 21 receives the RU profile information from the communication device RU 10, the determination unit 23a determines, based on the DU profile information and the RU profile information, whether or not the functions/services provided by the communication device DU 20 are supported by the communication device RU 10. In the example illustrated in FIG. 9, each of the functions/services provided by the communication device DU 20 is supported by the communication device RU 10.

When the FH interface unit 21 receives the RU_YANG module from the communication device RU 10, the determination unit 23a determines, based on the DU_YANG module and the RU_YANG module, whether or not the communication parameters related to the functions/services provided by the communication device DU 20 are supported by the communication device RU 10. In the embodiment illustrated in FIGS. 13A to 14B, the expected value of each communication parameter used by the communication device DU 20 falls within the valid range defined in the communication device RU 10. Furthermore, the determination unit 23a may determine whether or not the expected value of each communication parameter used by the communication device DU 20 matches the initial value defined in the communication device RU 10. When the expected value of the communication parameter used by the communication device DU 20 does not match the initial value defined in the communication device RU 10, the determination unit 23a may generate an update message instructing to update the corresponding initial value of the communication parameter in the RU_YANG module to the expected value of the communication parameter in the communication device DU 20. In this case, the FH interface unit 21 transmits the update message to the communication device RU 10.

When the expected value of the communication parameter related to the function/service provided by the communication device DU 20 does not fall within the valid range defined in the communication device RU 10, the determination unit 23a may output an error message. Furthermore, when the expected value of the communication parameter related to the function/service provided by the communication device DU 20 does not match the initial value defined in the communication device RU 10, and the corresponding initial value of the communication parameter in the RU_YANG module may not be updated, the determination unit 23a may output an error message. The error message is transmitted to the operator terminal 30 by the OP interface unit 24.

FIG. 16 is a flowchart illustrating an example of processing of the determination unit 23a. The determination unit 23a is mounted to the communication device DU 20. Furthermore, the processing of this flowchart corresponds to parameter determination executed in S7 illustrated in FIG. 4.

In S21, the determination unit 23a acquires the RU_YANG module and the RU parameter information from the communication device RU 10. In S22, the determination unit 23a selects a parameter to be determined from among the parameters used by the DU_YANG module. Then, the determination unit 23a recognizes an expected value of the selected parameter by referring to the DU parameter setting information stored in the storage unit 22. Note that, in the following description, the parameter selected in S22 may be referred to as a target parameter.

In S23, the determination unit 23a determines whether the expected value of the target parameter falls within the corresponding valid range of the parameter used in the communication device RU 10. Note that the valid range of each parameter used in the communication device RU 10 is represented by the RU parameter information received from the communication device RU 10.

When the expected value of the target parameter falls within the corresponding valid range of the parameter, the determination unit 23a determines, in S24, whether the expected value of the target parameter matches the corresponding initial value of the parameter used in the communication device RU 10. Note that the initial value of each parameter used in the communication device RU 10 is represented by the RU parameter information received from the communication device RU 10.

When the expected value of the target parameter matches the corresponding initial value of the parameter, the processing of the determination unit 23a proceeds to S27. When the expected value of the target parameter does not match the corresponding initial value of the parameter, the determination unit 23a determines whether the corresponding initial value of the parameter may be updated to the expected value of the target parameter in S25. Then, when the corresponding initial value of the parameter may be updated to the expected value of the target parameter, the determination unit 23a generates an update message in S26. This update message instructs to update the corresponding initial value of the parameter to the expected value of the target parameter.

In S27, the determination unit 23a determines whether the processing of S23 to S26 has been executed for all the parameters in the DU_YANG module. Here, when there remains a parameter for which the processing of S23 to S26 have not been executed, the processing of the determination unit 23a returns to S22. Then, the determination unit 23a selects the next parameter from the DU_YANG module. For example, the processing of S23 to S26 is executed for each parameter in the DU_YANG module. Then, when the processing of S23 to S26 is executed for all the parameters in the DU_YANG module, the processing of the determination unit 23a proceeds to S28.

In S28, the determination unit 23a determines whether each parameter in the DU_YANG module satisfies the following condition (1) or condition (2).

(1) The expected value of the target parameter falls within the corresponding valid range of the parameter in the communication device RU 10, and matches the corresponding initial value of the parameter in the communication device RU 10.

(2) The expected value of the target parameter falls within the corresponding valid range of the parameter in the communication device RU 10, and the corresponding initial value of the parameter in the communication device RU 10 may be updated to the expected value of the target parameter.

When all the parameters in the DU_YANG module satisfy the condition (1) or the condition (2), the determination unit 23a generates an activation instruction in S29. The activation instruction instructs to start a service of the radio access network. Then, the activation instruction is transmitted to the communication device RU 10. When the update message has been generated, the activation instruction and the update message are transmitted to the communication device RU 10.

Note that, when the expected value of the target parameter does not fall within the corresponding valid range of the parameter (S23: No), an error message is generated in S30. Furthermore, also when the corresponding initial value of the parameter may not be updated to the expected value of the target parameter (S25: No), an error message is generated in S30. The error message is transmitted to the operator terminal 30.

### <Hardware Configuration>

FIG. 17 illustrates an example of hardware configurations of the communication device RU 10 and the communication device DU 20. The communication device RU 10 includes a processor 41, a memory 42, a storage device 43, a communication interface circuit 44, and a radio circuit 45.

The processor 41 controls the operation of the communication device RU 10 by executing a communication program stored in the storage device 43. The communication program includes a program code describing a procedure for editing the RU_YANG module. Therefore, when the processor 41 executes this communication program, the function of the editing unit 13a is provided. The memory 42 is used as a work area for the processor 41. The storage device 43 stores the communication program described above and other programs. Furthermore, the RU profile information, the RU_YANG module, and the RU parameter setting information are stored in the storage device 43. The communication interface circuit 44 corresponds to the FH interface unit 11 illustrated in FIG. 15, and communicates with the communication device DU 20 via the fronthaul. The radio circuit 45 includes a radio transmitter that transmits a signal to the radio terminal and a radio receiver that receives a signal from the radio terminal.

The communication device DU 20 includes a processor 51, a memory 52, a storage device 53, and a communication interface circuit 54. For example, the configuration of the communication device DU 20 is substantially the same as that of the communication device RU 10. Note that a communication program executed by the processor 51 includes a program code describing a procedure for determining whether the functions/services of the communication device DU 20 are supported by the communication device RU 10. Therefore, when the processor 51 executes this communication program, the function of the determination unit 23a is provided. Furthermore, the communication device DU 20 does not include a radio circuit.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A communication device that accommodates a radio terminal in a radio access network, the communication device comprising:
an interface circuit configured to communicate with a second communication device that processes a signal of the communication device in the radio access network;
a storage configured to store a first profile that represents information related to a function provided by the communication device and control information that includes a communication parameter that corresponds to the first profile; and
processor circuitry configured to edit the control information,
wherein the interface circuit transmits the first profile to the second communication device, and receives a second profile that represents information related to a function provided by the second communication device from the second communication device,
the processor circuitry edits the control information based on the second profile,
the interface circuit transmits the edited control information to the second communication device, and
in the second communication device, when it is determined that a communication parameter related to the function provided by the second communication device is supported by the communication device based on the edited control information, the communication device starts a communication service based on the edited control information.

2. The communication device according to claim 1, wherein
the processor circuitry deletes description not related to the function provided by the second communication device from the control information based on the second profile.

3. The communication device according to claim 2, wherein
the processor circuitry generates parameter information that represents an initial value and a range of each communication parameter included in the edited control information, and
the interface circuit transmits the edited control information and the parameter information to the second communication device.

4. A communication device that processes a signal of a radio device that accommodates a radio terminal in a radio access network, the communication device comprising:
an interface circuit configured to communicate with the radio device;
a storage configured to store a first profile that represents information related to a function provided by the communication device and first control information that includes a communication parameter that corresponds to the first profile; and
processor circuitry configured to determine whether or not the function provided by the communication device is supported by the radio device,
wherein, when the interface circuit receives a second profile that represents information related to a function provided by the radio device from the radio device, determination processor circuitry determines whether or not the function provided by the communication device is supported by the radio device based on the first profile and the second profile, and
when the interface circuit receives second control information that includes a communication parameter that corresponds to the second profile from the radio device, the determination processor circuitry determines whether or not a communication parameter related to the function provided by the communication device is supported by the radio device based on the first control information and the second control information.

5. The communication device according to claim 4, wherein,
when the interface circuit receives parameter information that represents an initial value and a range of the communication parameter included in the second control information, the determination processor circuitry determines whether or not an expected value of the communication parameter related to the function provided by the communication device falls within the range of the communication parameter represented by the parameter information.

6. The communication device according to claim 5, wherein
the determination processor circuitry determines whether or not the expected value of the communication parameter related to the function provided by the communication device matches the initial value of the communication parameter represented by the parameter information.

7. The communication device according to claim 6, wherein,
when the expected value of the communication parameter related to the function provided by the communication device does not match the initial value of the communication parameter represented by the parameter information, the determination processor circuitry generates an update message that instructs to update the initial value of the communication parameter represented by the parameter information to the expected value of the communication parameter of the communication device, and
the interface circuit transmits the update message to the radio device.

8. The communication device according to claim 7, wherein,
when the expected value of the communication parameter related to the function provided by the communication device does not fall within the range of the communication parameter represented by the parameter information, the determination processor circuitry outputs an error message.

9. The communication device according to claim 7, wherein,
when the expected value of the communication parameter related to the function provided by the communication device does not match the initial value of the communication parameter represented by the parameter information and when it is not possible to update the initial value of the communication parameter represented by the parameter information to the expected value of the communication parameter of the communication device, the determination processor circuitry outputs an error message.

10. A communication system that includes a first communication device that accommodates a radio terminal and a second communication device that processes a signal of the first communication device, the communication system comprising:
by the second communication device,
acquiring a first profile that represents information related to a function provided by the first communication device from the first communication device;
determining whether or not a function provided by the second communication device is supported by the first communication device based on the first profile and a second profile that represents information related to the function provided by the second communication device; and
transmitting the second profile to the first communication device when the function provided by the second communication device is supported by the first communication device,
by the first communication device,
editing, based on the second profile, first control information that includes a communication parameter that corresponds to the first profile; and
transmitting the edited first control information to the second communication device, and
by the second communication device, determining whether or not a communication parameter related to the function provided by the second communication device is supported by the first communication device based on the first control information and second control information that includes a communication parameter that corresponds to the second profile.
